(19) United States
(12) Patent Application Publication
(10) Pub. No.: US 2025/0333036 A1
(43) Pub. Date: Oct. 30, 2025

(54) BRAKING SYSTEMS AND METHODS

(71) Applicant: Amsted Rail Company, Inc., Chicago, IL (US)

(72) Inventors: Paul Steven Wike, St. Louis, MO (US); Tom Petrunich, Glen Carbon, IL (US)

(73) Assignee: Amsted Rail Company, Inc., Chicago, IL (US)

(21) Appl. No.: 19/068,506

(22) Filed: Mar. 3, 2025

Related U.S. Application Data
(60) Provisional application No. 63/639,116, filed on Apr. 26, 2024.

(51) Int. Cl. B60T 13/58; B60T 8/171; B60T 8/172; B60T 11/10; B60T 11/28; B60T 13/68

(52) U.S. Cl. CPC B60T 13/588; B60T 8/171; B60T 8/172; B60T 11/103; B60T 11/28; B60T 13/683

(57) ABSTRACT

A braking system and method includes primary and secondary cylinder assemblies. The primary cylinder assembly includes an expandable structure that controls movement of a first piston rod. The secondary cylinder assembly includes a second piston rod disposed within a second cavity of a second housing. A compressed fluid moves from the primary assembly to the secondary cylinder assembly responsive to the expandable structure expanding. The second piston rod moves from a resting state to a compressed state responsive to at least some of the compressed fluid being received by the secondary assembly. A fluid control assembly controls a position of a valve between an open position and a closed position to allow or prohibit the compressed fluid from moving between the primary and secondary assemblies.

### CROSS-REFERENCE TO RELATED APPLICATIONS

This application relates to and claims priority benefits from U.S. Provisional Patent Application No. 63/639,116, filed Apr. 26, 2024, which is hereby incorporated by reference in its entirety.

### FIELD OF DISCLOSURE

Examples of the present disclosure generally relate to braking systems and methods.

### BACKGROUND OF THE DISCLOSURE

Train consists that are made up of several dozens of locomotives and railcars may include an air-brake system that includes an air-brake line that extends a length of the train consist. When the speed of movement of the train needs to change (e.g., slowed down, stopped, or the like), one or more signals are communicated to each of the individual braking systems disposed onboard the individual locomotives and railcars. The traditional air brake system charges the brake pressure on each car in the train to an over-the-road operating pressure through the train line. Once achieved, the train and every car within the train has air pressure stored to actuate the brakes. At the operating pressure, the pressure in the train line may be the same as the pressure stored within each car reservoir. Each car includes a valve (such as a triple valve) that is actuated by a differential pressure, represented as the pressure change of the train line compared to the individual car reservoir. A signal from the cab may direct a reduction of pressure of the train line. The pressure reduction in the train line creates the differential pressure of the train line compared to the individual car reservoir. Now each car in the train can receive pressure from its respective reservoir to actuate the brakes.

Often, while a train consist is moving within a cold-weather environment, various seals of the different braking systems onboard each of the locomotives and railcars may be compromised. For example, some of the seals of the different braking systems may fail to operate properly if the train consist is moving in an environment that has ambient temperature conditions that are outside of temperatures for which the seals may be rated. In certain instances, the seals may fail to properly seal the corresponding braking system, and the braking systems may fail to operate properly.

Known solutions present issues with leaking air-braking systems leading to inconsistent braking applications along a length of a train consist.

### SUMMARY OF THE DISCLOSURE

A need exists for a braking system and method for efficiently and effectively actuating a braking effort on one or more brakes of a vehicle, and engaging a parking brake of the braking system, thereby locking the brakes of the vehicle in a locked and/or engaged position. Further, a need exists for a braking system that automatically communicates a status of the braking system (e.g., if the brakes are engaged, if the parking brake is engaged, etc.) with an operator of the vehicle.

With those needs in mind, certain examples of the present disclosure provide a braking system having a primary cylinder assembly and a secondary cylinder assembly. The primary cylinder assembly includes a first piston rod that is disposed within a first cavity of a first housing. The first piston rod extends between a first end and a second end. The first end of the first piston rod is coupled with an expandable structure that moves between an expanded state and a retracted state. The first piston rod moves in a first direction responsive to the expandable structure moving toward the expanded state or in a second direction responsive to the expandable structure moving toward the retracted state.

The secondary cylinder assembly includes a second piston rod disposed within a second cavity of a second housing. The second piston rod extends between a third end disposed within the second cavity and a fourth end operably coupled with a lever device of a braking rigging system of a vehicle. A conduit extends between a first end that is fluidly coupled with the first cavity and a second end that is fluidly coupled with the second cavity. A compressed fluid moves from the first cavity toward the second cavity responsive to the expandable structure moving toward the expanded state. The second piston rod moves from a resting state to a compressed state responsive to at least some of the compressed fluid being received within the second cavity. A fluid control assembly includes a valve that is fluidly coupled with the conduit. The fluid control assembly includes a controller that controls a position of the valve between an open position and a closed position. The valve allows the compressed fluid to move between the first and second cavities while the valve is in the open position, or the valve prohibits the compressed fluid from moving between the first and second cavities while the valve is in the closed position.

Certain examples of the present disclosure provide a method for controlling operation of a braking system. The method includes directing at least some fluid into an expandable structure to change a state of the expandable structure from a retracted state to an expanded state. The expandable structure is operably coupled with a first piston rod disposed within a first cavity. Moving the expandable structure from the retracted state to the expanded state includes moving the first piston rod in a first direction. Moving the first piston rod in the first direction directs a compressed fluid from the first cavity toward a second cavity via a conduit.

At least some of the compressed fluid is received in the second cavity fluidly coupled with the first cavity. Receiving at least some of the compressed fluid includes moving a second piston rod from a resting state to a compressed state. The second piston rod in the compressed state is configured to control a braking effort of one or more brakes of a vehicle.

A position of a valve of the braking system is changed from an open position to a closed position. The valve in the closed position prevents the compressed fluid from moving between the first cavity and the second cavity and maintains a position of the primary cylinder assembly in the expanded state and the secondary cylinder assembly in the compressed state.

Certain examples of the present disclosure provide a vehicle braking system that includes a primary cylinder assembly including an expandable structure operably coupled with a first piston rod. The expandable structure moves the first piston rod in a first direction or a second direction responsive to the expandable structure moving between an expanded state and a retracted state. The first piston rod is configured to compress a fluid responsive to the first piston rod moving in the first direction.

The vehicle braking system also includes a secondary cylinder assembly including a second piston rod operably coupled with a lever device of a brake rigging system of a vehicle. The secondary cylinder assembly is fluidly coupled with the primary cylinder assembly. The secondary cylinder assembly moves between a resting state and a compressed state responsive to the secondary cylinder assembly receiving at least some of the compressed fluid from the primary cylinder assembly.

A fluid control assembly including a valve is fluidly coupled with the primary cylinder assembly and the secondary cylinder assembly. The valve may move between am open position and a closed position. The valve in the closed position is configured to maintain the expanded state between the control valve and the secondary cylinder assembly in the compressed state, or the valve in the open position is configured to allow the primary cylinder assembly to move between the expanded state and the retracted state, and allow the secondary cylinder assembly to move between the compressed state and the resting state.

### BRIEF DESCRIPTION OF THE DRAWINGS

FIG. 1 illustrates a perspective view of a braking system, according to an example of the present disclosure.

FIG. 2 illustrates a perspective transparent view of a primary cylinder assembly of the braking system shown in FIG. 1 in an expanded state, according to an example of the present disclosure.

FIG. 3 illustrates a perspective transparent view of the primary cylinder assembly of the braking system shown in FIG. 1 in a retracted state, according to an example of the present disclosure.

FIG. 4 illustrates a side view of the primary cylinder assembly shown in FIG. 3, according to an example of the present disclosure.

FIG. 5 illustrates a perspective transparent view of a secondary cylinder assembly of the braking system shown in FIG. 1 in a resting state, according to an example of the present disclosure.

FIG. 6 illustrates a perspective transparent view of the secondary cylinder assembly of the braking system shown in FIG. 1 in a compressed state, according to an example of the present disclosure.

FIG. 7 illustrates a perspective view of a fluid control assembly of the braking system shown in FIG. 1, according to an example of the present disclosure.

FIG. 8 illustrates a transparent top view of the fluid control assembly show in FIG. 4, according to an example of the present disclosure.

FIG. 9 illustrates a bottom side of a vehicle, according to an example of the present disclosure.

FIG. 10 illustrates a schematic of a braking system fluidly coupled with a brake line of the vehicle illustrated in FIG. 9, according to an example of the present disclosure.

FIG. 11 illustrates a flow chart of an example of a method for controlling operation of a braking system, according to an example of the present disclosure.

FIG. 12 illustrates a schematic of a braking system in a resting state, according to an example of the present disclosure.

FIG. 13 illustrates a display of a vehicle indicating a braking system of the vehicle system is in the resting state, according to an example of the present disclosure.

FIG. 14 illustrates a schematic of the braking system in an engaged state, according to an example of the present disclosure.

FIG. 15 illustrates a display of the vehicle indicating the braking system is in the engaged state, according to an example of the present disclosure.

FIG. 16 illustrates a schematic of the braking system in a locked engaged state, according to an example of the present disclosure.

FIG. 17 illustrates a display of the vehicle indicating the braking system is in the locked engaged state, according to an example of the present disclosure.

FIG. 18 illustrates a schematic of the braking system for releasing a parking brake of the braking system of the vehicle, according to an example of the present disclosure.

### DETAILED DESCRIPTION OF THE DISCLOSURE

The foregoing summary, as well as the following detailed description of certain embodiments, will be better understood when read in conjunction with the appended drawings. As used herein, an element or step recited in the singular and preceded by the word “a” or “an” should be understood as not necessarily excluding the plural of the elements or steps. Further, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular condition may include additional elements not having that condition.

Examples of the present disclosure provide a braking system for a vehicle. The braking system may include a primary cylinder assembly that is fluidly coupled with a secondary cylinder assembly. The primary cylinder assembly includes an expandable structure that can move between a retracted state and an expanded state. In one or more examples, the expandable structure may be fluidly coupled with an air-brake line of the vehicle, with a reservoir of the vehicle, or the like. The expandable structure is operably coupled with a first end of a first piston rod and a second end of the first piston rod is disposed within a first cavity of a first housing. The first piston rod may move in a first direction responsive to the expandable structure moving toward the expanded state, or in a second direction responsive to the expandable structure moving toward the retracted state.

The first cavity of the primary cylinder assembly is fluidly coupled with a second cavity of a second housing of the secondary cylinder assembly. The secondary cylinder assembly includes a second piston rod extending between a third end that is disposed within the second cavity and a fourth end that is disposed outside of the second cavity. The fourth end of the second piston rod is operably and/or pivotally coupled with a lever device of a brake rigging system of the vehicle. For example, the lever device operably couples the braking system with one or more brakes of the vehicle.

The first piston rod is configured to compress a fluid within the first cavity responsive to the expandable structure moving toward the expanded state. The compressed fluid is configured to be directed into the second cavity to move the second piston rod from a resting state toward a compressed state. Moving the second piston rod from the resting state to the compressed state changes a position of the lever device and applies a braking effort at one or more brakes of the vehicle to slow and/or stop movement of the vehicle.

The braking system also includes a fluid control assembly having a valve fluidly coupled with the first cavity and the second cavity. In one or more examples, the fluid control assembly may be referred to as a parking brake, a parking brake assembly, a parking brake controller, or the like. For example, the fluid control assembly may control operation of the valve to move between an open position and a closed position. While the valve is in the open position, the compressed fluid is allowed to move between the first and second cavities. For example, the primary cylinder assembly is allowed to move between the expanded state and the retracted state, and the secondary cylinder assembly is allowed to move between the resting state and the compressed state.

Alternatively, while the valve is in the closed position, the compressed fluid is prohibited from moving between the first and second cavities. For example, if the valve moves from the open position to the closed position while the primary cylinder assembly is in the expanded state and the secondary cylinder is in the compressed state, then the fluid from the closed control valve will remain in the expanded state and the secondary cylinder assembly will remain in the compressed state. For example, if the valve is moved from the open position to the closed position while the brakes of the vehicle are engaged, the brakes of the application will be locked in the engaged state and will remain engaged until the valve is moved from the closed position to the open position.

The braking system described herein may be disposed on plural different vehicles of a vehicle system, such as a train consist. One or more vehicles of the train consist may include a braking system as described herein. In one or more examples, each of the braking systems may include one or more sensors or alternative sensing and/or communicative device that may be communicatively coupled with a controller of the train consist, such as a controller disposed onboard a locomotive of the train consist. The sensors and/or other communicative devices may communicate a state of the braking system and/or a state of the fluid control assembly (e.g., the parking brake) with the locomotive. For example, an operator of the train consist may be positioned onboard the locomotive, and may receive information associated with the state of each braking system onboard the one or more vehicles of the train consist.

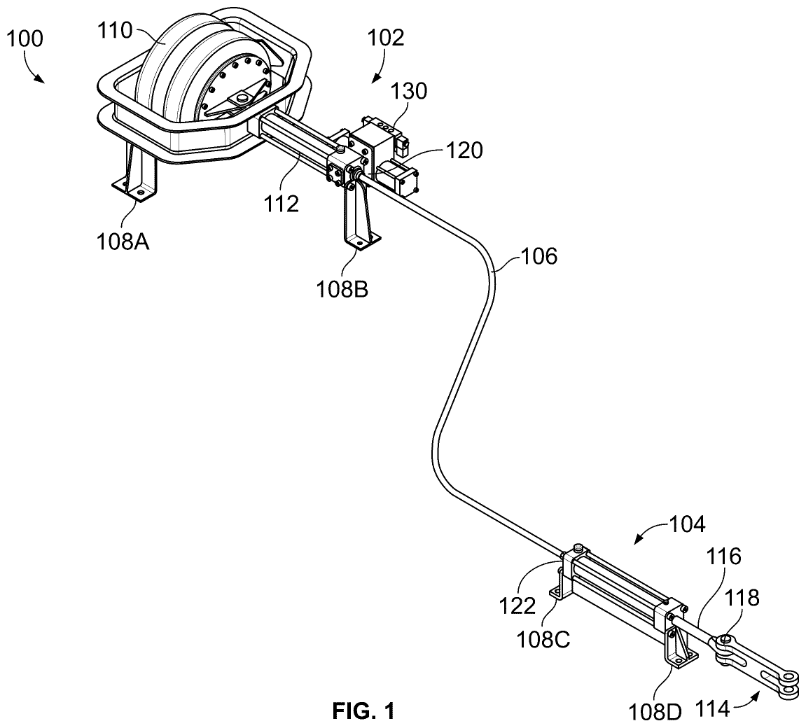

FIG. 1 illustrates a perspective view of a braking system 100, according to an example of the present disclosure. The braking system 100 includes a primary cylinder assembly 102, a secondary cylinder assembly 104, and a conduit 106 that extends between a first end 120 operably coupled with the primary cylinder assembly 102 and a second end 122 operably coupled with the secondary cylinder assembly 104. In one example, the conduit 106 include plural layers that may be manufactured of one or more different materials, such as to control one or more characteristics of the conduit 106 while a fluid moves through the conduit. For example, the conduit 106 could be designed and/or manufactured to control one or more thermal characteristics, one or more flow characteristics of the fluid, one or more of bending or a flexibility of the conduit, or the like.

The braking system 100 also includes a fluid control assembly 130 that controls one or more characteristics of a fluid that may move between the primary cylinder assembly 102 and the secondary cylinder assembly 104 via the conduit 106. For example, the one or more characteristics may include an amount or volume, a direction of flow, a flow rate, or the like, of a fluid moving between the primary and secondary cylinder assemblies 102, 104. The braking system 100 includes plural mounting structures 108A-D that couple the braking system 100 to a vehicle (not shown). In one or more examples, the fluid control assembly 130 may represent a parking brake of the braking system 100, that may be activated to lock, hold, or otherwise maintain the braking system 100 in an engaged or actuated state.

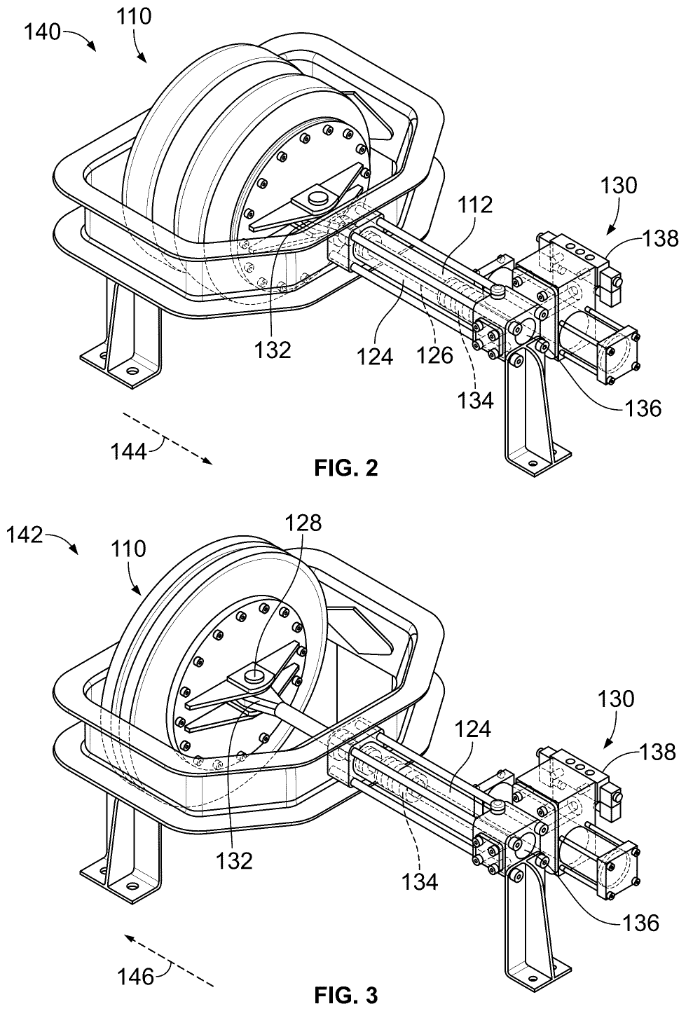

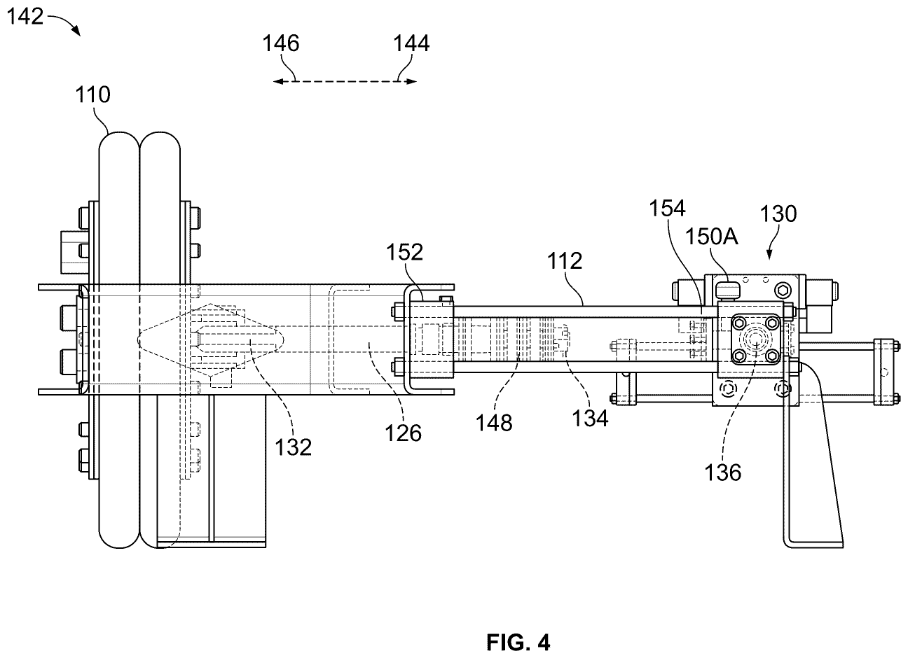

FIG. 2 illustrates a perspective transparent view of the primary cylinder assembly 102 in an expanded state 140, FIG. 3 illustrates a perspective transparent view of the primary cylinder assembly 102 in a retracted state 142, and FIG. 4 illustrates a side view of the primary cylinder assembly 102 in the retracted state 142, according to an example of the present disclosure. Referring to FIGS. 1-4, the primary cylinder assembly 102 includes an expandable structure 110 that is operably coupled with the mounting structure 108A. In one example, the expandable structure 110 may include an internal cavity (not shown) and may be manufactured of a flexible material allowing the expandable structure to expand and collapse based on air moving into or out of the internal cavity of the expandable structure 110. In one or more embodiments, a diameter of the primary cylinder and/or a diameter of the secondary cylinder may be shaped and/or sized to provide similar force as existing brake cylinder sizes.

The primary cylinder assembly 102 includes a first housing 112 that extends between a first end 152 and a second end 154. The first housing 112 includes one or more internal surfaces defining a first cavity 124 disposed within the first housing 112. The primary cylinder assembly 102 includes a first piston rod 126 that extends between a first end 132 and a second end 134. The first end 132 of the first piston rod 126 extends out of and a distance away from the first end 152 of the first housing 112 and is operably coupled with the expandable structure 110 via a coupling feature 128. The second end 134 of the first piston rod 126 is disposed within the first cavity 124 of the first housing 112. In one or more examples, the first cavity 124 may have a diameter that is about 3 in, about 4 in, or the like, and the first piston rod 126 may have a stroke that is about 5 in, about 7 in, about 9 in, or the like.

The first piston rod 126 is configured to move in a first direction 144 towards the second end 154 of the first housing 112 or in a second direction 146 towards the first end 152 of the first housing 112. In one example, the first piston rod 126 moves in the first or second directions 144, 146 responsive to the expandable structure 110 moving between the expanded state 140 and the retracted state 142, respectively. In another example, the first piston rod 126 may move in the first or second directions 144, 146 responsive to a fluid moving into or out of the first cavity 124, such as via the conduit 106.

In one or more examples, the first piston rod 126 may include one or more seals 148 that may extend around at least a portion of a circumference of the first piston rod 126. For example, the one or more seals 148 may engage the one or more internal surfaces of the first housing 112 that define the first cavity 124.

In one or more examples, the primary cylinder assembly 102 includes a valve 150A that may be used to control an amount of fluid that is disposed within the first cavity 124, such as during an installation process, during a maintenance process, during a repair process, or the like. In one example, the valve 150A may represent a Schrader valve.

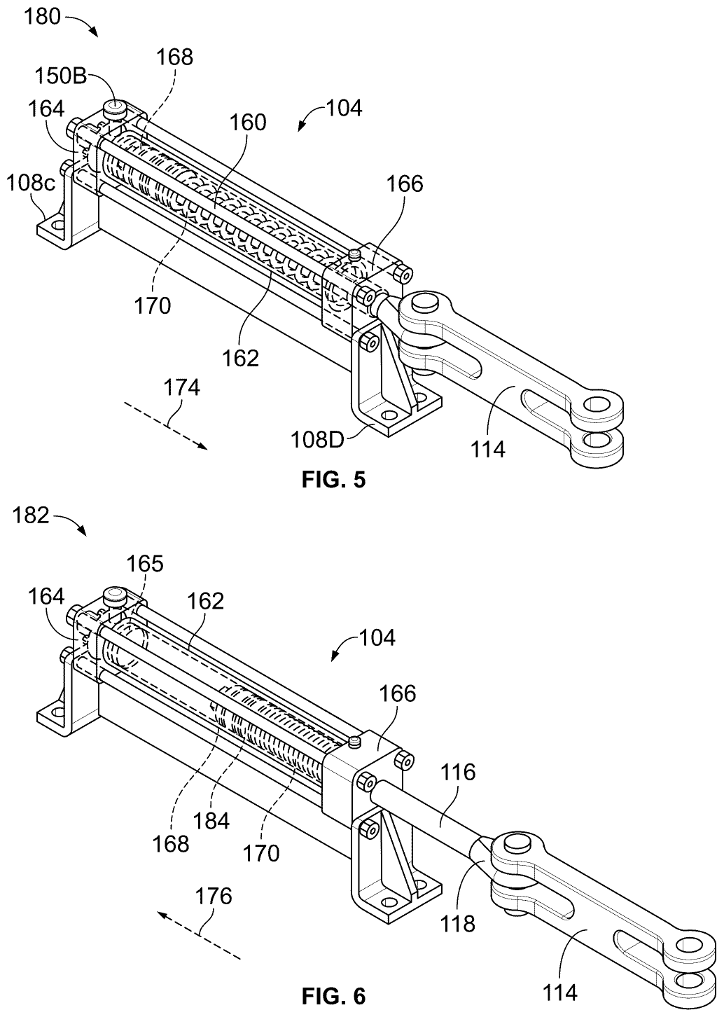

FIG. 5 illustrates a perspective transparent view of the secondary cylinder assembly 104 in a resting state 180, and FIG. 6 illustrates a perspective transparent view of the secondary cylinder assembly 104 in a compressed state 182, according to an example of the present disclosure. Referring to FIGS. 1, 5, and 6, the secondary cylinder assembly 104 includes a second housing 160 that extends between a third end 164 and a fourth end 166. The second housing 160 includes one or more interior surfaces that define a second cavity 162 that is disposed and extends within a portion of the second housing 160. The second end 122 of the conduit 106 is fluidly coupled with the second cavity 162 of the second housing 160 via a passage 165 disposed at the third end 164 of the second housing 160.

The second cylinder assembly 104 includes a second piston rod 116 that extends between a first end 168 and a second end 118. The first end 168 of the second piston rod 116 is disposed within the second cavity 162 and the second end 118 of the second piston rod 116 extends a distance away from the fourth end 166 of the second housing 160. In one or more examples, the second cavity 162 may have a diameter that is about 2 in, about 3 in, or the like, and the second piston rod 116 may have a stroke that is about 5 in, about 7 in, about 9 in, or the like.

In one or more examples, the first end 168 of the second piston rod 116 may include one or more seals 184 that may extend around at least a portion of a circumference of the second piston rod 116. For example, the one or more seals 184 may engage with the one or more internal surfaces of the second housing 160 that define the second cavity 162.

The second end 118 of the second piston rod 116 is pivotally coupled with a lever device 114. In one example, the lever device 114 may operably couple the second piston rod 116 with a brake rigging system (not shown) of a vehicle.

The secondary cylinder assembly 104 also includes a spring device 170 disposed within the second cavity 162 of the second housing 160. In the illustrated example, the spring device 170 is a compression spring that extends around a portion of the second piston rod 116. The second piston rod 116 may move in a third direction 174 (e.g., toward the compressed state 182) responsive to a fluid being directed into the second cavity 162 via the conduit 106. For example, the fluid may be a compressed fluid that is directed out of the first cavity 124 of the first housing and into the second cavity 162 of the second housing 160 via the conduit 106. Alternatively, the second piston rod 116 may move in a fourth direction 176 (e.g., toward the resting state 180) responsive to at least some fluid being directed out of the second cavity 162 and into the conduit 106. In one example, the spring device 170 may be shaped and sized to be at rest within the second cavity 162 while the secondary cylinder assembly 104 is in the resting state 180, and may exert a spring force in the fourth direction 176 while the secondary cylinder is in the compressed state 182. For example, the spring device 170 may encourage the second piston rod 116 to move from the compressed state 182 to the resting state 180.

In one or more examples, the secondary cylinder assembly 104 may include a valve 150B that may be used to control an amount of fluid that is disposed within the second cavity 162, such as during an installation process, during a maintenance process, during a repair process, or the like. In one example, the valve 150B may represent a Schrader valve.

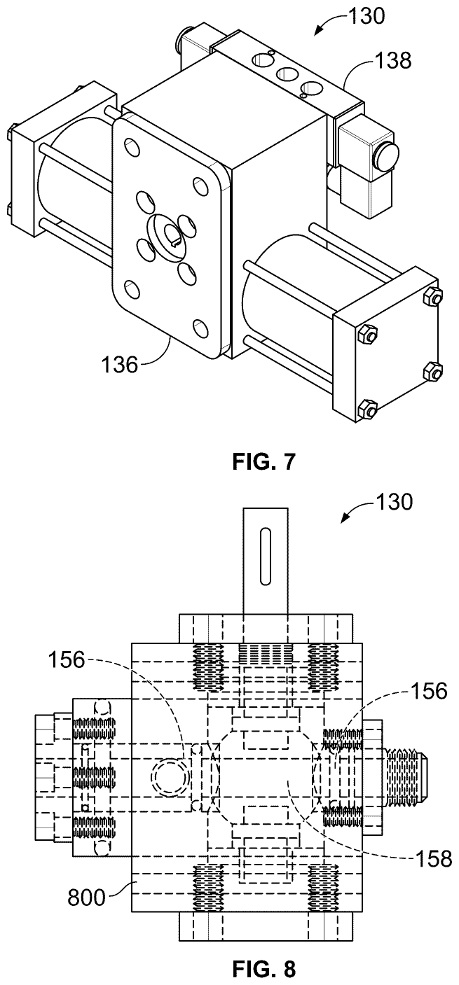

FIG. 7 illustrates a perspective view of the fluid control assembly 130, and FIG. 8 illustrates a transparent top view of a portion of the fluid control assembly 130, according to an example of the present disclosure. Referring to FIGS. 1-4 and 7-8, the fluid control assembly 130 is operably coupled with and disposed proximate to the second end 154 of the first housing 112. The fluid control assembly 130 includes a rotational device 136 (e.g., a rack and pinion rotational device operated by one or more air cylinders) and a controller 138 that may control operation of and/or a position of the rotational device 136 between an open position or closed positions. The fluid control assembly may include a valve 800 is positioned between the second end 154 of the first housing 112 and the first end 120 of the conduit 106 and fluidly couples the conduit 106 with the first cavity 124 of the primary cylinder assembly 102. For example, the valve 800 may control one or more characteristics of the compressed fluid that may flow between the first cavity 124 of the primary cylinder assembly 102 and the conduit 106. In another example, the fluid control assembly 130 may be positioned between the second end 122 of the conduit 106 and the third end 164 of the second housing 160 of the secondary cylinder assembly 104. For example, the valve may control one or more characteristics of the compressed fluid that may flow between the conduit 106 and the second cavity 162 of the secondary cylinder assembly 104.

In one or more examples, the rotational device 136 of the fluid control assembly 130 may be referred to as a rotary actuator that includes a ball 158 disposed within a bore of the valve 800. In one or more examples, the ball 158 may have about a lin diameter, about a 2 in diameter, or the like. The controller 138 may include one or more solenoid devices that may control a direction of rotation of the ball 158 within the rotational device 136 to move the valve 800 to an open position or a closed position. In alternative examples, the valve 800 may be another type and/or classification of valve having one or more additional and/or alternative components that may be used to allow or prevent the flow of fluid through the valve. In one example, the valve 800 may include one or more seals 156 that may be shaped, sized, and/or positioned to engage with a portion of an exterior surface of the ball 158 based on a position of the ball 158 of the valve 800 within the bore.

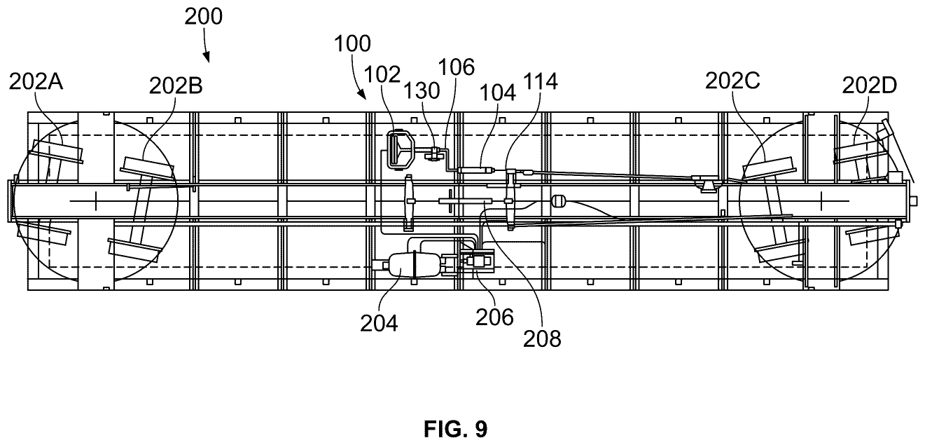

In one or more examples, the fluid control assembly 130 may be referred to as a parking brake or parking brake assembly and/or the controller 138 may be referred to as a parking brake controller. For example, the braking system 100 may be coupled with one or more brakes of a vehicle. In one example, the vehicle may be included in a vehicle system (not shown) such as a train consist that may include plural vehicles that are mechanically coupled together and move together along a route. One or more of the vehicles of the train consist may include a braking system 100 disposed thereon that may control one or more brakes of the respective vehicle. For example, FIG. 9 illustrates a bottom view of a vehicle 200, according to an example of the present disclosure. The vehicle 200 includes plural wheel sets 202A-D and a rigging system 208 that includes linkages that operably connect corresponding brakes of the wheelsets 202A-D with the braking system 100. In one example, the lever device 114 may be operably coupled with and extend between the rigging system 208 and the braking system 100.

The vehicle 200 also includes a reservoir 204 that may be a tank or container that may receive and/or store fluid, such as a brake fluid from an air-brake line that extends along a length of the train consist (not shown). The reservoir 204 may be operably coupled with a brake line control valve 206 that may control an amount of brake fluid that is directed into or out of the reservoir 204 via the brake line (not shown) of the train consist.

During operation of the vehicle 200, a speed of movement of the vehicle 200 may need to be reduced or the vehicle 200 may need to be stopped, and a braking effort of the vehicle 200 may need to change. The braking system 100 may be controlled such that the expandable structure 110 of the primary cylinder assembly 102 may receive air from the reservoir 204 to move to the expanded state 140, thereby causing the secondary cylinder assembly 104 to move from the resting state 180 to the compressed state 182 while the valve 800 of the fluid control assembly 130 is in an open position. Moving the secondary cylinder assembly 104 to the compressed state 182 changes a position of the lever device 114 operably coupled with the second piston rod 116 and the rigging system 208 of the vehicle 200 to change and/or control a braking effort of the one or more brakes of the vehicle.

In one example, the braking application may stop movement of the vehicle 200. In order to ensure that the vehicle 200 remains in the stopped position, a parking brake may need to be applied to the vehicle 200. For example, while the primary cylinder assembly 102 is in the expanded state and the secondary cylinder assembly 104 is in the compressed state 182 and the brakes of the vehicle 200 are engaged, the fluid control assembly 130 may change a position of the valve 800 from the open position to a closed position. While the valve 800 is in the closed position, fluid disposed within the second cavity 162 of the secondary cylinder assembly 104 is prevented from moving out of the second cavity 162 via the conduit 106, and fluid disposed within the first cavity 124 of the primary cylinder assembly 102 is preventing from moving out of the first cavity 124 via the conduit 106. For example, the primary cylinder assembly 102 may remain in the extended state 140 and the secondary cylinder assembly 104 may remain in the compressed state 182. The fluid control assembly 130 (e.g., the parking brake assembly) may lock and/or hold a position of the primary cylinder assembly 102 in the expanded state and the secondary cylinder assembly 104 in the compressed state responsive to the valve 136 moving from the open position to the closed position.

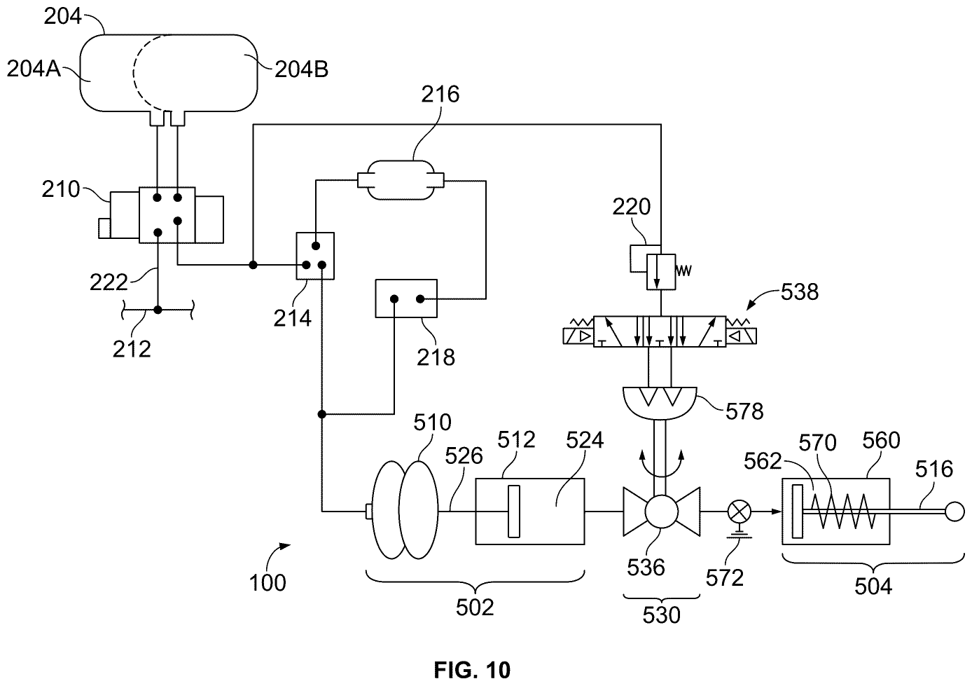

FIG. 10 illustrates a schematic of the braking system 100 fluidly coupled for air transfer with a train line 212 of the vehicle 200 illustrated in FIG. 9, according to an example of the present disclosure. The train line 212 is fluidly coupled for air transfer with the reservoir 204 via a brake line 222 and a first valve 210. In the illustrated example, the first valve 210 represents a triple valve such that the first valve 210 may control movement of air through the first valve 210 in two directions. The reservoir 204 may include a first portion 204A that can represent an auxiliary reservoir and a second portion 204B that can represent an emergency reservoir.

In the illustrated embodiment, the reservoir 204 may represent a primary reservoir 204, and the vehicle 200 may also include a secondary reservoir 216 that is fluidly coupled with the brake line 222 and the primary reservoir 204 via a second valve 214. In one embodiment, the second valve 214 may be referred to as a proportioning valve that may regulate the pressure of brake air between the empty or loaded vehicle 200. The secondary reservoir 216 is also fluidly coupled with a third valve 218, which may represent a sensor valve that may sense or detect if the vehicle 200 is empty or is carrying a load. For example, the third valve 218 may represent an empty/load sensor device.

The third valve 218 (e.g., the empty/load device) is positioned between the braking system 100 and the secondary reservoir 216. For example, the third valve 218 may regulate the fluid that may be directed to the braking system 100 from the secondary reservoir 216, such as based on a weight of the vehicle 200, based on a weight of the cargo being carried by the vehicle 200, or the like. The braking system 100 includes a primary cylinder assembly 502 that includes an expandable structure 510 that is operably coupled with a first piston rod 526 that is disposed within a first cavity 524 of a first housing 512. The braking system 100 also includes a secondary cylinder assembly 504 that includes a second housing 560. A first portion of a second piston rod 516 is disposed within a second cavity 562 of the second housing 560 and is operably coupled with a spring device 570. A second portion of the second piston rod 516 is disposed outside of the second housing 560 and may be operably coupled with the rigging system 208 of the vehicle 200 via the lever device 114 to change and/or control a braking effort of the one or more brakes of the vehicle.

The braking system also includes a fluid control assembly 530 that is positioned between the primary cylinder assembly 502 and the secondary cylinder assembly 504. In one or more embodiments, the fluid control assembly 530 may be referred to as an air control assembly, a control assembly, or the like, that controls a flow of air within the braking system. The fluid control assembly 530 includes a valve 536 that is operably coupled with a rack pinion mechanism 578. In one embodiment, the valve 536 may represent a ball valve, or an alternative valve device that can be opened or closed to control fluids moving through the valve. The ball valve 536 and the rack pinion mechanism 578 may be controlled by a controller 538 that includes and/or represents one or more solenoids or solenoid valves that may be used to control a position of the ball valve 536 between an open position and a closed position.

In one or more examples, the fluid control assembly 530 and/or the braking system 100 may include and/or be operably coupled with a power source (not shown). The power source may provide electric power to the controller 538 to control operation of the controller 538. In one example, the power source may be an energy storage device, such as a battery or battery system. As another example, the power source may be another powered system disposed onboard the vehicle 200. As another example, the controller 538 may be operably coupled with a bus, wire, or other wired connection of the train consist.

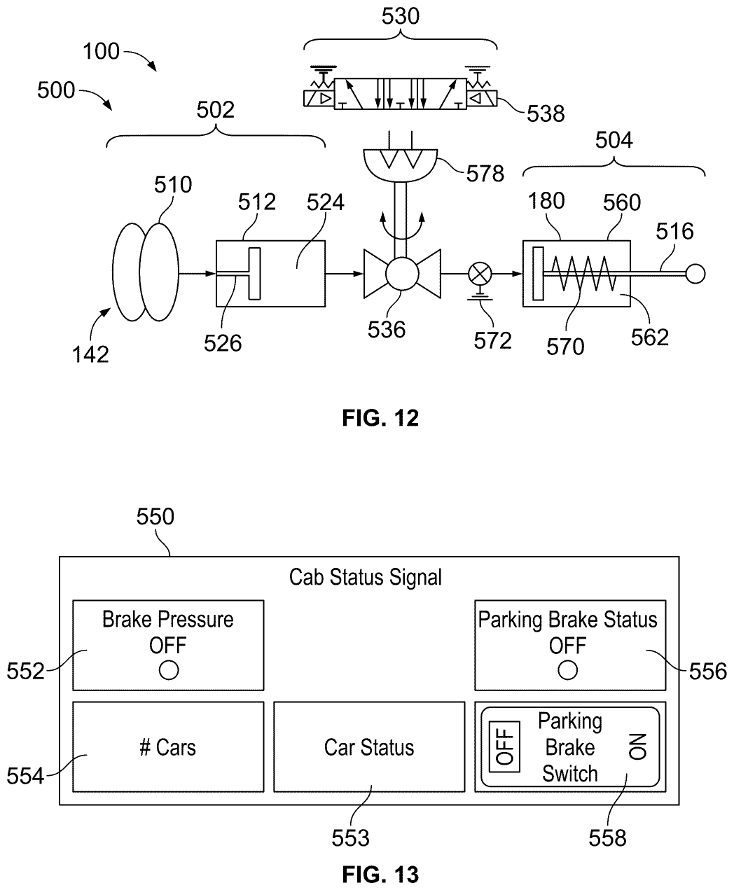

In one example, the braking system also includes a first sensor 572, that may represent a pressure transducer. The first sensor 572 may communicate a signal to a controller of the train consist (not shown) indicating a pressure of a fluid that may be moving out of the ball valve 536. For example, the first sensor 572 may communicate a signal indicating that the braking system is not engaged or is at rest. In another example, the braking system may include one or more additional and/or alternative sensors that may detect one or more characteristics of the braking system, the primary cylinder assembly 502, the secondary cylinder assembly 504, the fluid control assembly 530, the conduit (not shown in FIG. 12), or at least some of the fluid disposed and/or moving within the braking system. The sensors may communicate one or more signals indicating the sensed characteristics, such as with a controller of a locomotive of the train consist, with a controller disposed off-board the train consist, or the like.

In one or more embodiments, the vehicle 200 may also include a fourth valve 220, which can represent a control valve that is fluidly positioned between the braking system 100 and the controller 538 of the braking system 100. For example, the control or fourth valve 220 may be opened and/or closed to control a flow of fluid into the controller 538 to control operation of the rack pinion mechanism 578.

The illustrated embodiment of FIG. 10 is for example purposes only. In alternative examples, the vehicle 200 may include one or more additional or alternative control valves, sensors, reservoirs, or the like, that may be used to control and/or monitor the operation of the braking system 100.

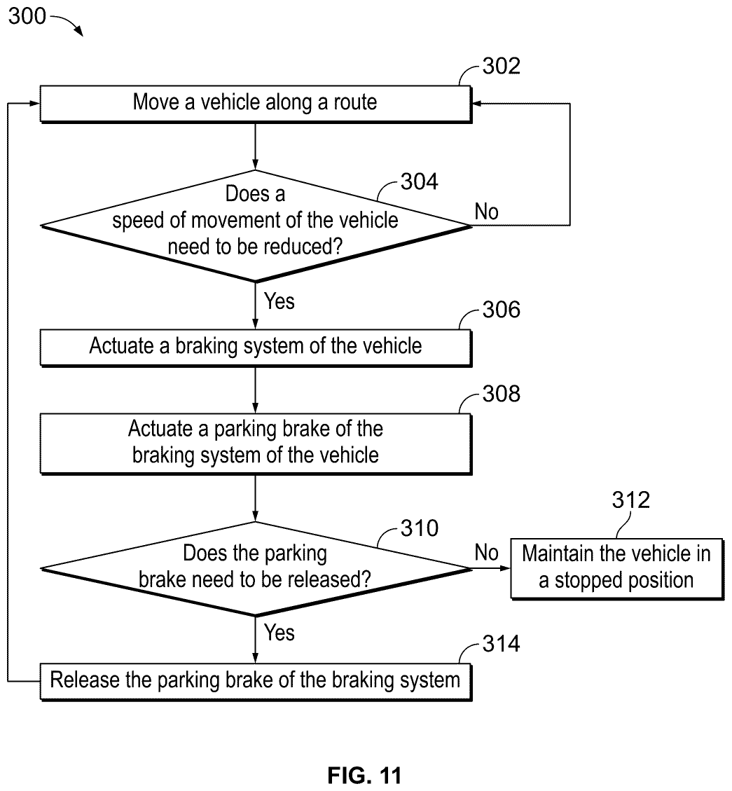

FIG. 11 illustrates a flow chart 300 of an example of a method for controlling operation of the braking system 100, according to an example of the present disclosure. At 302, the vehicle 200 may move along the route, such as with other vehicles in a train consist. The vehicle 200 may include the braking system 100 and may be fluidly coupled with an air-brake line of the train consist.

In one example, the braking system 100 may be disengaged, or at rest, while the vehicle 200 moves along the route. In the illustrated example of FIG. 12, the primary cylinder assembly 502 is in the retracted state 142 and the secondary cylinder assembly 504 is in the resting state 180. In one example, the first sensor 572 may communicate a signal to a controller of the train consist indicating that there is no change in pressure of fluids moving between the primary and secondary cylinder assemblies 502, 504, indicative that the braking system 100 is at rest. The sensors may communicate one or more signals indicating the sensed characteristics, such as with a controller of a locomotive of the train consist, with a controller disposed off-board the train consist, or the like.

FIG. 13 illustrates a display 550 that may be visible to an operator of the train consist. The operator may be onboard or off-board the train consist. The display 550 may indicate a braking status, a parking brake status, an error or problem status, or the like, of one or more locomotives or cars within the train consist. For example, the display 550 may provide a status update and/or information associated with each individual car within the consist, may provide actions required by the operator to activate or release different parking brakes on different cars within the consist, or the like.

In the illustrated example, the display 550 includes a first section 552 that indicates whether or not a brake pressure has been applied to one or more cars within the consist; and a second section that indicates a number of cars within the consist that have activated a brake pressure. The display 550 may also include a third section 553 that indicates if an issue has been detected at one or more of the cars within the consist. In one or more examples, the issue indicated on the display 550 may be that an energy storage device (not shown) of the braking system onboard a vehicle has insufficient energy stored therein to set the parking brake, that the amount of stored energy may be insufficient to last a duration of a trip, or the like. In one example, if multiple locomotives are experiencing an issue, the display 550 may individually display each car number one at a time and in indication of the issue associated with the corresponding train car. The display 550 may include a fourth section 556 that indicates if the parking brake is on or off (e.g., engaged or disengaged); and a fifth section 558 that can indicate if the parking brake switch is an on position or an off position. In one or more examples, the operator may change the position of the parking brake switch between the on and off positions, or alternatively a controller (not shown) of the train consist may automatically change positions of the parking brake switch between the on and off positions.

In the illustrated example of FIG. 13, the display 550 indicates to the operator of the train consist that the braking system illustrated in FIG. 12 is not engaged (e.g., is at rest), that no train cars are reporting that the corresponding brakes are actuated, that no train cars are reporting status issues, that the parking brake is not engaged, and that the parking brake activation switch is in the off position.

The display 550 illustrated in FIG. 13 is for illustrative purposes only. In other embodiments, the display 550 may have an alternative arrangement, may display or provide additional or alternative information to an operator of the consist, or the like. Optionally, the display 550 may be an interactive display that may allow the operator to interact with or change one or more settings of the display, to change a type of information that is displayed, to change an arrangement of the data that is displayed, or the like.

Returning to FIG. 11, at 304, a determination is made whether the speed of movement of the vehicle 200 needs to be reduced. If the speed of movement of the vehicle 200 does not need to be reduced and a braking effort does not need to be applied to brakes of the vehicle 200, then flow of the method returns to 302 and the vehicle continues to move along the route.

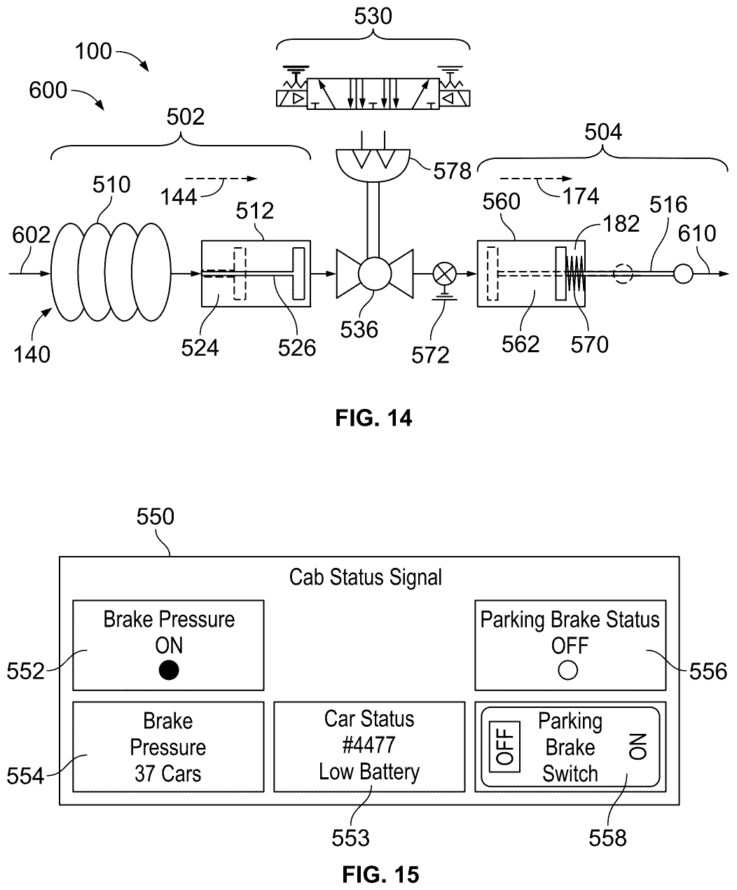

Alternatively, if the speed of movement of the vehicle 200 needs to be reduced, flow of the method proceeds toward 306. At 306, the braking system of the vehicle 200 may be actuated. FIG. 14 illustrates a schematic of the braking system in an engaged state 600, according to an example of the present disclosure. The expandable structure 510 of the primary cylinder assembly 502 may receive air 602, such as from the secondary reservoir 216 of the vehicle 200. The air 602 may have a pressure between about 10 pounds per square inch (psi) and about 70 psi. In alternative embodiments, the air 602 may have a pressure between about 10 psi and about 90 psi.

The expandable structure 510 may expand responsive to receiving the air 602, which causes the first piston rod 526 to move in the first direction 144 towards the second end of the first housing 512. Moving the first piston rod 526 in the first direction 144 may pressurize at least some of a fluid disposed within the first cavity 524 and at least some of the pressurized fluid may be directed toward the ball valve 536 of the fluid control assembly 530.

The ball valve 536, in the open position, may allow the pressurized fluid to move through the ball valve 536, into the conduit, and into the second cavity 562 of the secondary cylinder assembly 504. The pressurized fluid from the primary cylinder assembly 502 may cause the second piston rod to move in the third direction 174, thereby compressing the spring device 570. For example, a force of the pressurized fluid received within the second cavity 562 from the primary cylinder assembly 502 may be greater than a spring force of the spring device 570. In one example, the spring force may be about 1170 pounds (lbs) and a parking force 610 may be about 10,000 lb. For example, the parking force 610 may be translated to the lever device (not shown in FIG. 14), which may control movement of the rigging system 208 of the vehicle 200 to apply a braking effort to brakes of the wheelsets 202A-D.

The first sensor 572 may communicate a signal to a controller of the train consist (not shown) indicating a pressure of the fluid that moves from the primary cylinder assembly 502 toward the secondary cylinder assembly 504. For example, the signal may indicate that the braking system of the vehicle 200 is actuated and/or the brakes of the vehicle are engaged. For example, FIG. 15 illustrates the display 550 that may be displayed to the operator of the train consist. The first section 552 may indicate that the brakes have been activated and the second section 554 may indicate that the brakes have been activated on 37 cars. The third section 553 may indicate that there is an issue with a particular car within the consist. The fourth and fifth sections 556, 558 may indicate that the parking brake is off (e.g., disengaged, deactivate, or the like) and that the parking brake switch is in the off position.

After the train has stopped, at 308, a parking brake of the braking system of the vehicle 200 is actuated. For example, the parking brake switch may be moved from the off position to the on position (e.g., automatically or manually by the operator of the consist) and the fluid control assembly 530 may control operation of the ball valve 536 to actuate, engage, and/or set a parking brake of the vehicle 200. In one or more embodiments, the parking brake may not be engaged until the train has stopped and may be engaged or actuated while the train is idling, may be engaged for long periods at a time (e.g., 30 minutes, 1 hour, 24 hours, 1 week, or the like), or the like.

In one or more embodiments, the parking brake may not be engaged or disengaged until a predetermined pressure of air within the brake line 222 upstream from the second valve 214 (e.g., the proportional valve illustrated in FIG. 10) is met or achieved. For example, the parking brake may not be actuated until the pressure of the air within the brake line 222 is at least at or above a first designated threshold (e.g., about 60 psi, about 70 psi, about 80 psi, about 90 psi, or the like). Additionally, the parking brake may not be released until the pressure of the air within the brake line 222 is at least or above a second designated threshold (e.g., about 64 psi, about 70 psi, about 80 psi, about 90 psi, or the like). The first and second designated thresholds may provide a safety mechanism in order to allow the parking brake to be engaged or disengaged only when the first and/or second designated thresholds are met.

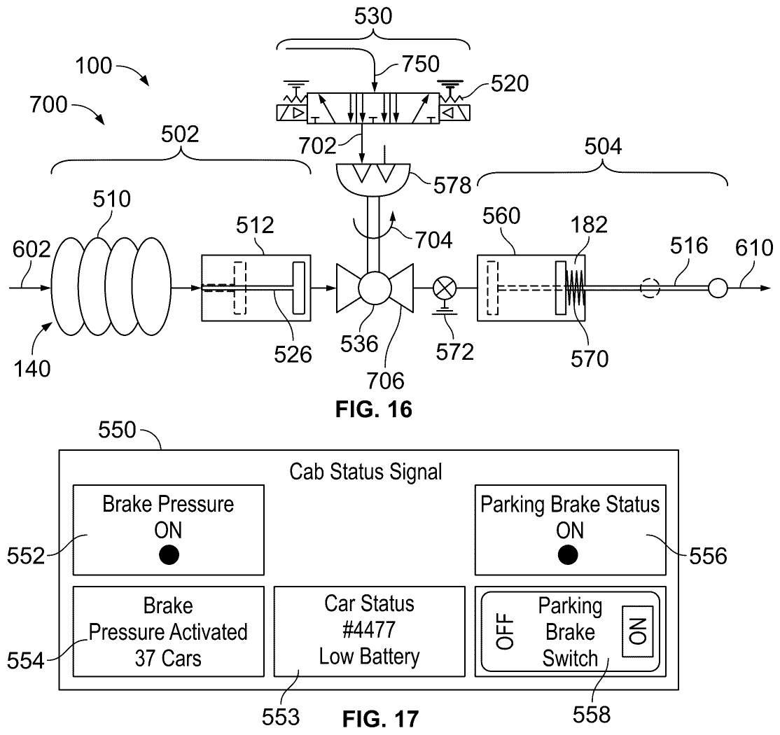

FIG. 16 illustrates a schematic of the braking system in a locked engaged state 700, according to an example of the present disclosure. For example, while the braking system is engaged (e.g., as shown in FIG. 14), the fluid control assembly 530 may lock the braking system in the engaged state. In the illustrated example, the fluid control assembly 530 may receive a first signal 750 from the fourth valve 220 (shown in FIG. 10). In one example, an operator of the vehicle may remotely initiate the first signal 750 to be directed to the fluid control assembly. As another example, a controller of the vehicle consist (not shown) may automatically initiate the first signal to be directed to the fluid control assembly.

In one or more embodiments, the parking brake may be set, engaged, turned on, activated, or the like, responsive to a pressure within the brake line 222 reaching a determined threshold value, such as about 90 psi. Responsive to a pressure of the fluid within the brake line 222 at a location upstream of the second valve 214 (e.g., the proportional valve) reaching a determined threshold, the ball valve 536 of the braking system 100 may be closed. For example, the operator of the consist may provide a pressure reduction of the fluid in the train line 212 (e.g., about a 20 psi reduction, about a 30 psi reduction, or the like). Responsive to the pressure reduction of the fluid in the train line 212, the first valve 210 (e.g., the triple valve 210 illustrated in FIG. 10) may sense or detect a difference between a pressure of fluid within the train line 212 and a pressure of fluid within the primary reservoir 204 (e.g., the auxiliary reservoir 204A). In order to balance the pressure differential between the train line 212 and the reservoir 204, the first valve 210 may release pressure from the primary reservoir 204 to the primary cylinder assembly 502. The fluid control assembly 530 may remain locked out until the threshold pressure in the valve 220 is reached. After the determined pressure threshold (e.g., about 64 psi) is reached, the operator may change the position of the parking brake switch to the on position.

The first signal 750 may actuate a first solenoid valve 702 of the fluid control assembly 530. The activation of the first solenoid valve 702 may direct pressurized air into the rack pinion mechanism 578 (e.g. the pneumatic actuator) to rotate the ball valve 536 about 90 degrees in a first direction 704 (e.g., a counter-clockwise CCW direction). Rotating the ball valve 536 about 90 degrees in the first direction 704 changes the position of the ball valve 536 from an open position to a closed position 706. For example, compressed fluid is prohibited from moving between the primary cylinder assembly 502 and the secondary cylinder assembly 504 while the ball valve 536 is in the closed position 706. While the ball valve 536 is in the closed position 706, the parking brake of the vehicle 200 is engaged, actuated, or the like.

In one example, the fluid control assembly 530 may include a second sensor 520 which may represent a proximity sensor, or the like. The second sensor 520 may sense or otherwise detect a position of the ball valve 536 between the open or closed positions. The sensor may communicate a signal including the sensed data to the controller of the train consist (not shown) or an off-board controller (not shown) indicating that the ball valve 536 is in the closed position 706. For example, FIG. 17 illustrates the display 550 that may be visible to an operator of the train consist. Like the display 550 illustrated in FIG. 15, the first section 552 may indicate that the brakes have been activated and the second section 554 may indicate that the brakes have been activated on 37 cars within the consist. The third section 553 may indicate that there is an issue with a particular car within the consist. The fourth section 556 may indicate that the parking brake is on, activated, engaged, etc., and the fifth section 558 may indicate that the operator has moved the parking brake switch to the on position. For example, the fourth section 556 may indicate to the operator that the ball valve 536 is in the closed position, thereby locking or preventing the release of the brakes.

Returning to FIG. 11, at 310, a determination is made if the parking brake needs to be released. If the parking brake does not need to be released, then flow of the method proceeds toward 312 and the vehicle remains in the stopped position with the braking system engaged and the parking brake actuated. Alternatively, if the parking brake needs to be released, flow of the method proceeds toward 314.

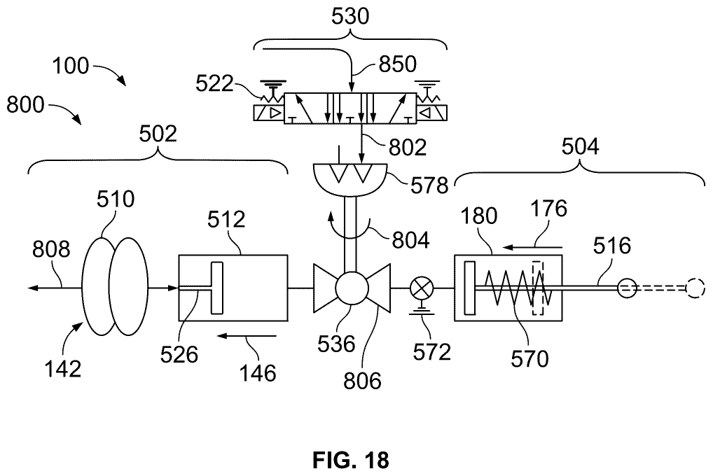

At 314, the parking brake of the braking system may be released, unengaged, turned off, or the like. FIG. 18 illustrates a schematic of the braking system for releasing the parking brake of the braking system of the vehicle 200, according to an example of the present disclosure. In one example, the operator of the vehicle may manually change a position of the parking brake switch from the on position to the off position. As another example, a controller (not shown) of the vehicle may automatically change the position of the parking brake switch to the off position.

In order to change the position of the parking brake switch to the off position, pressures of air within the train line 212, within the brake line 222, within the reservoir 204, or the like, may need to reach a predetermined threshold, such as about 90 psi. Responsive to the pressures of the fluids reaching the predetermined threshold, the operator may reduce a pressure of the air within the train line 212, such as by about 30 psi, to achieve a pressure of about 64 psi at the brake line 222 upstream from or in front of the second valve 214 (e.g., the proportional valve). When the reduced pressure is achieved, the position of the parking brake switch may be automatically or manually turned to the off position.

Additionally, responsive to the reduced pressure (e.g., about 64 psi) being reached, the fluid control assembly 530 may receive a second signal 850 from the fourth valve 220 (e.g., the control valve). The second signal 850 may actuate a second solenoid valve 802 of the fluid control assembly 530 that may direct pressurized air into the rack pinion mechanism 578 to rotate the ball valve 536 about 90 degrees in a second direction 804 (e.g., a clockwise direction). Rotating the ball valve 536 about 90 degrees in the second direction 804 changes the position of the ball valve 536 from the closed position 706 (shown in FIG. 16) to an open position 806. For example, compressed fluid is allowed to move between the primary cylinder assembly 502 and the secondary cylinder assembly 504 while the ball valve 536 is in the open position. For example, while the ball valve 536 is in the open position 806, the parking brake of the vehicle 200 is disengaged, de-activated, turned off, or the like.

In one example, the fluid control assembly 530 may include a third sensor 522 which may represent a proximity sensor, or the like. The third sensor 522 may detect or otherwise sense a position of the ball valve 536 in the open position 806, and may communicate a signal including the sensed data to the controller of the train consist or another off-board controller (not shown). The signal may indicate that the ball valve 536 is in the open position 806. In an alternative example, the second and third sensors 520, 522 may represent a single proximity sensor. Optionally, the braking system and/or the fluid control assembly 530 may include two or more different sensors that may be used to detect and/or sense different characteristics of one or more different components of the fluid control assembly 530. Additionally, first sensor 572 may communicate a signal to a controller of the train consist or an off-board controller (not shown) indicating that the braking system is not engaged, or is at rest. The display 550 that may be visible to the operator of the train consist may have an arrangement that is similar to the display 550 shown in FIG. 13. For example, the display may indicate to the operator of the train consist that the braking system is not engaged (e.g., is at rest), that there are no train cars reporting the brakes are actuated, that there are no train cars that are reporting status issues, that the parking brake is not engaged, and that the parking brake activation switch is in the off position.

In one or more embodiments, the brakes of the vehicle 200 may remain engaged, activated, or the like, until the operator of the vehicle 200 releases air 808 from the expandable structure 510 of the primary cylinder assembly 502, such as to the reservoir 204, to atmosphere (e.g., directed as exhaust out of the vehicle 200), even though the ball valve 536 is opened and the parking brake has been disengaged. For example, the brake system 100 may still be activated and the brakes may remain engaged subsequent to the parking brake being released.

In one example, responsive to the parking brake being turned off or disengaged, the air 808 may be directed out of the braking system 100 and a spring force of the spring device 570 may encourage the second piston rod 516 to move in the fourth direction 176 towards the resting state 180 of the secondary cylinder assembly 504. Moving the second piston rod 516 in the fourth direction 176 may direct at least some of the pressurized fluid from the second cavity 562 toward the first cavity 524 of the primary cylinder assembly 502 via the conduit fluidly coupling the first and second cavities 524, 562. For example, the return spring force of the spring device 570 may push the first piston rod 526 in the second direction 146 and the expandable structure 510 toward the retracted state 142. For example, at least some of the air 808 disposed within the expandable structure 510 may be directed out of the expandable structure responsive to the expandable structure moving toward a compressed or collapsed state. Additionally, moving the second piston rod 516 in the fourth direction 176 translates to movement of the lever device (not shown in FIG. 18) in the fourth direction 176 to disengage the brakes of the wheelsets 202A-D.

Further, the disclosure comprises embodiments according to the following clauses:

Clause 1: a braking system, comprising:
a primary cylinder assembly including a first piston rod disposed within a first cavity of a first housing, the first piston rod extending between a first end and a second end, the primary cylinder assembly including an expandable structure operably coupled with the first end of the first piston rod, wherein the expandable structure is configured to move between an expanded state and a retracted state responsive to a fluid moving into or out of a cavity of the expandable structure, wherein the first piston rod is configured to move in a first direction responsive to the expandable structure moving toward the expanded state or the first piston rod is configured to move in a second direction responsive to the expandable structure moving toward the retracted state;
a secondary cylinder assembly including a second piston rod disposed within a second cavity of a second housing, the second piston rod extending between a third end and a fourth end, wherein the third end of the second piston rod is configured to be disposed in the second cavity and the fourth end of the second piston rod is configured to be disposed outside of the second cavity and be operably coupled with a lever device of a brake rigging system of a vehicle;
a conduit extending between a first end fluidly coupled with the first cavity of the first housing and a second end fluidly coupled with the second cavity of the second housing, wherein a compressed fluid is configured to move from the first cavity toward the second cavity responsive to the expandable structure moving toward the expanded state, wherein the second piston rod is configured to move from a resting state to a compressed state responsive to at least some of the compressed fluid being received within the second cavity; and
a fluid control assembly comprising a valve fluidly coupled with the conduit, the fluid control assembly comprising a controller configured to control a position of the valve between an open position and a closed position,
wherein the valve is configured to allow the compressed fluid to move between the first cavity and the second cavity while the valve is in the open position, and the valve is configured to prohibit the compressed fluid to move between the first cavity and the second cavity while the valve is in the closed position.

Clause 2: the braking system of clause 1, wherein the secondary cylinder assembly includes a spring device disposed within the second cavity and extending around a portion of the second piston rod, wherein the spring device is configured to exert a spring force on the third end of the second piston rod responsive to at least some of the compressed fluid being received within the second cavity.

Clause 3: the braking system of clause 2, wherein the spring device is configured to exert a spring force on to the third end of the second piston rod that is less than a braking effort force exerted onto the lever device via the fourth end of the second piston rod.

Clause 4: the braking system of clause 3, wherein the brake rigging system comprises plural linkages operably coupled with brakes of the vehicle, wherein the braking effort force is configured to control a position of the linkages to engage one or more brakes of the vehicle to one or more of control a speed of movement of the vehicle or stop movement of the vehicle.

Clause 5: the braking system of any of clauses 1-4, the fluid control assembly further comprising an actuating mechanism and a controller, wherein the controller is configured to control operation of the actuating mechanism to move the valve between the open position and the closed position.

Clause 6: the braking system of any of clauses 1-5, wherein the fluid control assembly is configured to move the valve from the open position to the closed position while the vehicle is stopped.

Clause 7: the braking system of clause 6, wherein the valve in the closed position is configured to maintain a position of the primary cylinder assembly in the expanded state and the secondary cylinder assembly in the compressed state.

Clause 8: the braking system of any of clauses 1-7, wherein the valve in the open position is configured to allow the primary cylinder assembly to move between the expanded state and the retracted state, and allow the secondary cylinder assembly to move between the compressed state and the resting state.

Clause 9: the braking system of any of clauses 1-8, further comprising one or more sensors configured to detect one or more characteristics of the valve, wherein the sensors are configured to communicate one or more signals to a controller indicating a position of the valve between the open position and the closed position.

Clause 10: the braking system of any of clauses 1-9, further comprising one or more sensors configured to detect one or more characteristics of the compressed fluid configured to move between the first cavity and the second cavity.

Clause 11: the braking system of any of clauses 1-10, wherein the fluid control assembly is configured to receive a fluid to control movement of the valve, wherein the fluid control assembly is configured to move the valve from the open position to the closed position responsive to the fluid having a pressure exceeding a designated threshold.

Clause 12: the braking system of any of clause 1-11, wherein the expandable structure is configured to be fluidly coupled with a reservoir of the vehicle, wherein the reservoir is configured to be fluidly coupled with an air-brake line of a vehicle system that includes the vehicle.

Clause 13: the braking system of any of clauses 1-12, wherein the second piston rod is configured to move from the compressed state to the resting state responsive to the valve moving from the closed position to the open position, wherein at lease some compressed air is configured to be directed from the second cavity toward the first cavity responsive to the second piston rod moving toward the resting state.

Clause 14: the braking system of clause 13, wherein the first piston rod is configured to move in the second direction responsive to at least some of the compressed air being directed from the second cavity toward the first cavity via the conduit, and the expandable structure is configured to move from the expanded state to the retracted state responsive to the first piston rod moving in the second direction.

Clause 15: a method, comprising:
directing at least some fluid into an expandable structure to change a state of the expandable structure from a retracted state to an expanded state, wherein the expandable structure is configured to be operably coupled with a first piston rod disposed within a first cavity, wherein moving the expandable structure from the retracted state to the expanded state includes moving the first piston rod in a first direction, wherein moving the first piston rod in the first direction is configured to direct a compressed fluid from the first cavity toward a second cavity via a conduit,
receiving at least some of the compressed fluid in the second cavity fluidly coupled with the first cavity, wherein receiving the at least some of the compressed fluid includes moving a second piston rod from a resting state to a compressed state, wherein the second piston rod in the compressed state is configured to control a braking effort of one or more brakes of a vehicle; and
changing a position of a valve of the braking system from an open position to a closed position, wherein the valve in the closed position is configured to prevent the compressed fluid from moving between the first cavity and the second cavity and maintain a position of the primary cylinder assembly in the expanded state and the secondary cylinder assembly in the compressed state.

Clause 16: method of clause 15, further comprising changing a position of the valve from the closed position to the open position, wherein the valve in the open position is configured to allow the primary cylinder assembly to move between the expanded state and the retracted state, and allow the secondary cylinder assembly to move between the compressed state and the resting state.

Clause 17: the method of clauses 15 or 16, further comprising changing the position of the valve from the open position to the closed position while the vehicle is stopped.

Clause 18: the method of any of clauses 15-17, further comprising detecting one or more characteristics of the valve, and communicating the one or more detected characteristics of the valve with a controller.

Clause 19: the method of any of clauses 15-18, further comprising changing the position of the valve of the braking system between the open position and the closed position responsive to determining that a pressure of a fluid exceeds a designated threshold.

Clause 20: a vehicle braking system, comprising:
a primary cylinder assembly including an expandable structure operably coupled with a first piston rod, the expandable structure configured to move the first piston rod in a first direction or a second direction responsive to the expandable structure moving between an expanded state and a retracted state, wherein the first piston rod is configured to compress a fluid responsive to the first piston rod moving in the first direction;
a secondary cylinder assembly including a second piston rod operably coupled with a lever device of a brake rigging system of a vehicle, the secondary cylinder assembly fluidly coupled with the primary cylinder assembly, wherein the secondary cylinder assembly is configured to move between a resting state and a compressed state responsive to the secondary cylinder assembly receiving at least some of the compressed fluid from the primary cylinder assembly; and
a fluid control assembly comprising a valve fluidly coupled with the primary cylinder assembly and the secondary cylinder assembly, the valve configured to move between an open position and a closed position,
wherein the valve in the closed position is configured to maintain a position of the primary cylinder assembly in the expanded state and the secondary cylinder assembly in the compressed state, or the valve in the open position is configured to allow the primary cylinder assembly to move between the expanded state and the retracted state, and allow the secondary cylinder assembly to move between the compressed state and the resting state.

While various spatial and directional terms, such as top, bottom, lower, mid, lateral, horizontal, vertical, front and the like may be used to describe embodiments of the present disclosure, it is understood that such terms are merely used with respect to the orientations shown in the drawings. The orientations may be inverted, rotated, or otherwise changed, such that an upper portion is a lower portion, and vice versa, horizontal becomes vertical, and the like.

The diagrams of examples herein may illustrate one or more control or processing units. It is to be understood that the processing or control units may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like. Optionally, the control unit(s) may represent processing circuitry such as one or more of a field programmable gate array (FPGA), application specific integrated circuit (ASIC), microprocessor(s), and/or the like. The circuits in various examples may be configured to execute one or more algorithms to perform functions described herein. The one or more algorithms may include aspects of examples disclosed herein, whether or not expressly identified in a flowchart or a method.

As used herein, the terms “software” and “firmware” are interchangeable, and include any computer program stored in a data storage unit (for example, one or more memories) for execution by a computer, including RAM memory, ROM memory, EPROM memory, EEPROM memory, and non-volatile RAM (NVRAM) memory. The above data storage unit types are exemplary only, and are thus not limiting as to the types of memory usable for storage of a computer program.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments of the disclosure without departing from their scope. While the dimensions and types of materials described herein are intended to define the parameters of the various embodiments of the disclosure, the embodiments are by no means limiting and are exemplary embodiments. Many other embodiments will be apparent to those of skill in the art upon reviewing the above description. The scope of the various embodiments of the disclosure should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112 (f), unless and until such claim limitations expressly use the phrase “means for” followed by a statement of function void of further structure.

This written description uses examples to disclose the various embodiments of the disclosure, including the best mode, and also to enable any person skilled in the art to practice the various embodiments of the disclosure, including making and using any devices or systems and performing any incorporated methods. The patentable scope of the various embodiments of the disclosure is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A braking system, comprising:
a primary cylinder assembly including a first piston rod disposed within a first cavity of a first housing, the first piston rod extending between a first end and a second end, the primary cylinder assembly including an expandable structure operably coupled with the first end of the first piston rod, wherein the expandable structure is configured to move between an expanded state and a retracted state responsive to a fluid moving into or out of a cavity of the expandable structure, wherein the first piston rod is configured to move in a first direction responsive to the expandable structure moving toward the expanded state or the first piston rod is configured to move in a second direction responsive to the expandable structure moving toward the retracted state;
a secondary cylinder assembly including a second piston rod disposed within a second cavity of a second housing, the second piston rod extending between a third end and a fourth end, wherein the third end of the second piston rod is configured to be disposed in the second cavity and the fourth end of the second piston rod is configured to be disposed outside of the second cavity and be operably coupled with a lever device of a brake rigging system of a vehicle;
a conduit extending between a first end fluidly coupled with the first cavity of the first housing and a second end fluidly coupled with the second cavity of the second housing, wherein a compressed fluid is configured to move from the first cavity toward the second cavity responsive to the expandable structure moving toward the expanded state, wherein the second piston rod is configured to move from a resting state to a compressed state responsive to at least some of the compressed fluid being received within the second cavity; and
a fluid control assembly comprising a valve fluidly coupled with the conduit, the fluid control assembly comprising a controller configured to control a position of the valve between an open position and a closed position,
wherein the valve is configured to allow the compressed fluid to move between the first cavity and the second cavity while the valve is in the open position, and the valve is configured to prohibit the compressed fluid to move between the first cavity and the second cavity while the valve is in the closed position.

2. The braking system of claim 1, wherein the secondary cylinder assembly includes a spring device disposed within the second cavity and extending around a portion of the second piston rod, wherein the spring device is configured to exert a spring force on the third end of the second piston rod responsive to at least some of the compressed fluid being received within the second cavity.

3. The braking system of claim 2, wherein the spring device is configured to exert a spring force on to the third end of the second piston rod that is less than a braking effort force exerted onto the lever device via the fourth end of the second piston rod.

4. The braking system of claim 3, wherein the brake rigging system comprises plural linkages operably coupled with brakes of the vehicle, wherein the braking effort force is configured to control a position of the linkages to engage one or more brakes of the vehicle to one or more of control a speed of movement of the vehicle or stop movement of the vehicle.

5. The braking system of claim 1, the fluid control assembly further comprising an actuating mechanism and a controller, wherein the controller is configured to control operation of the actuating mechanism to move the valve between the open position and the closed position.

6. The braking system of claim 1, wherein the fluid control assembly is configured to move the valve from the open position to the closed position while the vehicle is stopped.

7. The braking system of claim 6, wherein the valve in the closed position is configured to maintain a position of the primary cylinder assembly in the expanded state and the secondary cylinder assembly in the compressed state.

8. The braking system of claim 1, wherein the valve in the open position is configured to allow the primary cylinder assembly to move between the expanded state and the retracted state, and allow the secondary cylinder assembly to move between the compressed state and the resting state.

9. The braking system of claim 1, further comprising one or more sensors configured to detect one or more characteristics of the valve, wherein the sensors are configured to communicate one or more signals to a controller indicating a position of the valve between the open position and the closed position.

10. The braking system of claim 1, further comprising one or more sensors configured to detect one or more characteristics of the compressed fluid configured to move between the first cavity and the second cavity.

11. The braking system of claim 1, wherein the fluid control assembly is configured to receive a fluid to control movement of the valve, wherein the fluid control assembly is configured to move the valve from the open position to the closed position responsive to the fluid having a pressure exceeding a designated threshold.

12. The braking system of claim 1, wherein the expandable structure is configured to be fluidly coupled with a reservoir of the vehicle, wherein the reservoir is configured to be fluidly coupled with an air-brake line of a vehicle system that includes the vehicle.

13. The braking system of claim 1, wherein the second piston rod is configured to move from the compressed state to the resting state responsive to the valve moving from the closed position to the open position, wherein at lease some compressed air is configured to be directed from the second cavity toward the first cavity responsive to the second piston rod moving toward the resting state.

14. The braking system of claim 13, wherein the first piston rod is configured to move in the second direction responsive to at least some of the compressed air being directed from the second cavity toward the first cavity via the conduit, and the expandable structure is configured to move from the expanded state to the retracted state responsive to the first piston rod moving in the second direction.

15. A method, comprising:
directing at least some fluid into an expandable structure to change a state of the expandable structure from a retracted state to an expanded state, wherein the expandable structure is configured to be operably coupled with a first piston rod disposed within a first cavity, wherein moving the expandable structure from the retracted state to the expanded state includes moving the first piston rod in a first direction, wherein moving the first piston rod in the first direction is configured to direct a compressed fluid from the first cavity toward a second cavity via a conduit;
receiving at least some of the compressed fluid in the second cavity fluidly coupled with the first cavity, wherein receiving the at least some of the compressed fluid includes moving a second piston rod from a resting state to a compressed state, wherein the second piston rod in the compressed state is configured to control a braking effort of one or more brakes of a vehicle; and
changing a position of a valve of the braking system from an open position to a closed position, wherein the valve in the closed position is configured to prevent the compressed fluid from moving between the first cavity and the second cavity and maintain a position of the primary cylinder assembly in the expanded state and the secondary cylinder assembly in the compressed state.

16. The method of claim 15, further comprising changing a position of the valve from the closed position to the open position, wherein the valve in the open position is configured to allow the primary cylinder assembly to move between the expanded state and the retracted state, and allow the secondary cylinder assembly to move between the compressed state and the resting state.

17. The method of claim 15, further comprising changing the position of the valve from the open position to the closed position while the vehicle is stopped.

18. The method of claim 15, further comprising detecting one or more characteristics of the valve, and communicating the one or more detected characteristics of the valve with a controller.

19. The method of claim 15, further comprising changing the position of the valve of the braking system between the open position and the closed position responsive to determining that a pressure of a fluid exceeds a designated threshold.

20. A vehicle braking system, comprising:
a primary cylinder assembly including an expandable structure operably coupled with a first piston rod, the expandable structure configured to move the first piston rod in a first direction or a second direction responsive to the expandable structure moving between an expanded state and a retracted state, wherein the first piston rod is configured to compress a fluid responsive to the first piston rod moving in the first direction;
a secondary cylinder assembly including a second piston rod operably coupled with a lever device of a brake rigging system of a vehicle, the secondary cylinder assembly fluidly coupled with the primary cylinder assembly, wherein the secondary cylinder assembly is configured to move between a resting state and a compressed state responsive to the secondary cylinder assembly receiving at least some of the compressed fluid from the primary cylinder assembly; and
a fluid control assembly comprising a valve fluidly coupled with the primary cylinder assembly and the secondary cylinder assembly, the valve configured to move between an open position and a closed position,
wherein the valve in the closed position is configured to maintain a position of the primary cylinder assembly in the expanded state and the secondary cylinder assembly in the compressed state, or the valve in the open position is configured to allow the primary cylinder assembly to move between the expanded state and the retracted state, and allow the secondary cylinder assembly to move between the compressed state and the resting state.
